(19) United States
(12) Patent Application Publication
(10) Pub. No.: US 2017/0223280 A1
(43) Pub. Date: Aug. 3, 2017

(54) SPORTS TELEVISION CAMERA ASSIGNMENT

(71) Applicant: Michael Glenn, Calabasas, CA (US)

(72) Inventor: Michael Glenn, Calabasas, CA (US)

(21) Appl. No.: 15/491,284

(22) Filed: Apr. 19, 2017

Related U.S. Application Data
(63) Continuation of application No. 15/393,974, filed on Dec. 29, 2016.
Application No. 15/393,974 is a continuation of application No. 15/227,126, filed on Aug. 3, 2016, now abandoned.
Application No. 15/227,126 is a continuation of application No. 15/075,711, filed on Mar. 21, 2016, now abandoned.
Application No. 15/075,711 is a continuation of application No. 10/872,265, filed on Jun. 18, 2004, now abandoned.

(51) Int. Cl. H04N 5/247; H04N 7/18; H04N 5/232

(52) U.S. Cl. CPC H04N 5/247; H04N 5/23203; H04N 7/181

(57) ABSTRACT

An arrangement of cameras and method for televising a baseball game includes first and second cameras positioned equidistant from home plate and first and third bases, the camera height above the playing field and the camera distance from the first and third baselines being chosen so that a ray to each camera, from an origin at the midpoint between the bases opposite the baseball diamond from that camera, rises at between 3.7 degrees and 7.9 degrees above horizontal. Alternatively, the ray rises at between 3.7 degrees and 6.1 degrees above horizontal. Distance, height, or both in combination are manipulated, within the structural constraints of the venue, to achieve this angle. The first or second camera is selected when a ball is hit. Third and subsequent cameras are subsequently selected, and the first and second camera may be re-framed and subsequently re-selected, in accordance with predetermined rules.

### CROSS REFERENCE TO RELATED APPLICATIONS

This application is a continuation of U.S. application Ser. No. 15/393,974, filed Dec. 29, 2016 which is a continuation of U.S. application Ser. No. 15/227,126, filed Aug. 3, 2016 which is a continuation of U.S. application Ser. No. 15/075,711, filed Mar. 21, 2016 which is a continuation of U.S. application Ser. No. 10/872,265, filed Jun. 18, 2004, the contents of both which are incorporated by reference in their entirety herein.

### BACKGROUND OF THE INVENTION

Field of the Invention

The present invention relates to the use of motion picture cameras to cover baseball games.

Description of the Related Art

Television coverage of a Major League Baseball game shows the viewing audience only a small part of the action. Often excluded from play-by-play baseball coverage are the relationships of the fielders, the runners, and the ball to one another.

### SUMMARY OF THE INVENTION

It is an object of the present invention to provide an improved camera assignment and method for television or movie recording of a sports event and, more particularly, a baseball game.

In accordance with this object and with others which will be described and which will become apparent, an exemplary embodiment of a sports television camera assignment in accordance with the present invention comprises an arrangement of motion picture cameras for recording a baseball game including at least one camera located substantially equidistant from the ends of one of the first base line and the third base line and on a ray rising at an angle less than 7.9 degrees above horizontal from an origin at the midpoint between the bases opposite the one base line (i.e., the first or third baseline).

Also in accordance with the same objects, in an exemplary embodiment of a sports television camera assignment in accordance with the present invention, the ray rises at an angle less than 6.1 degrees above horizontal.

In another exemplary embodiment in accordance with the present invention, the ray rises at an angle between 3.7 and 7.9 degrees above horizontal.

In another exemplary embodiment, a high-home-base camera is located behind and substantially above home base.

In another exemplary embodiment, a second camera is located substantially equidistant from the ends of the other of said first and third base lines and on a ray rising at an angle less than 7.9 degrees above horizontal from an origin at the midpoint between the bases opposite that other base line.

In another exemplary embodiment, the ray to the second camera rises at an angle less than 6.1 degrees above horizontal.

In another exemplary embodiment, the ray to the second camera rises at an angle between 3.7 and 7.9 degrees above horizontal.

Also in accordance with the same objects, an exemplary embodiment in accordance with the present invention includes at least one camera located substantially equidistant from the ends of one of the first base line (defined by home and first base) and the third base line (defined by home and third base); that at least one camera being at a height between 5 meters and 6 meters above ground; that at least one camera being at a distance of between 43 meters and 73 meters from the midpoint between the bases opposite said one base line (second and third, or first and second, respectively).

In another exemplary embodiment, that at least one camera is at a distance of between 43 and 58 meters from the midpoint between the bases opposite that one base line.

In another exemplary embodiment, a second camera is located substantially equidistant from the ends of the other of the first and third base lines; the second camera being located substantially equidistant from the ends of the other base lines; the second camera being at a height of between 5 meters and 6 meters above ground; the second camera being at a distance of between 43 meters and 73 meters form the midpoint between the bases opposite the other base line.

Also in accordance with those methods, an exemplary method of using motion picture cameras to record a baseball game includes the steps of locating a first camera substantially equidistant from the ends of one of the first base line (defined by home and first base) and the third base line (defined by home and third base) and on a ray rising at an angle less than 7.9 degrees above horizontal from an origin at the midpoint between the bases opposite said one base line (second and third, or first and second, respectively); locating a second camera substantially equidistant from the ends of the other of the first and third base lines and on a ray rising at an angle less than 7.9 degrees above horizontal from an origin at the midpoint between the bases opposite the other base line; and, when a player hits a ball, selecting the first camera if the ball travels substantially to the left of second base and selecting the second camera if the ball travels substantially to the right thereof.

Steps may be added of locating a high-home-base camera behind and substantially above home base and assigning that high-home-base camera to following and isolating play action close up. The step may be added of selecting the first camera if the ball travels substantially toward or over second base and there are no runners on base and, additionally, framing the first camera substantially about the ball and the runner who hit the ball and following the runner and the ball.

Another exemplary method includes the step of selecting the first camera if the ball travels substantially toward or over second base and there is a runner on first base. The step may be added of framing the first camera substantially about the ball and the runner going to second base and following the runner and the ball.

Another exemplary method includes the step of selecting the second camera if the ball travels substantially towards or over second base and a runner is on second base. A step may be added of framing the second camera substantially about the ball and the runner going to third base and following the runner and the ball.

Another exemplary method includes the step of selecting the first camera if the ball travels substantially toward or over second base and a runner is on third base. A step may be added of framing the first camera substantially about the ball and the runner going to first base and following the runner and the ball.

Another exemplary method includes the steps of selecting the second camera if the ball travels substantially toward or over second base and runners are on first and second bases.

Another exemplary method includes the step of framing the second camera substantially about the ball and the runners going to second base and third base and following the runners and the ball.

Another exemplary method includes the step of selecting the first camera if the ball travels substantially toward or over second base and runners are on first and third bases. A step may be added of framing the first camera substantially about the ball and the runner going to second base and following the runner and the ball.

Another exemplary method includes the step of selecting the second camera if the ball travels substantially toward or over second base and runners are on second and third bases. A step may be added of framing the second camera substantially about the ball and the runner going to third base and following the runner and the ball.

Another exemplary method includes the step of selecting the second camera if the ball travels substantially toward or over second base and runners are on first, second and third bases. A step may be added of framing the second camera substantially about the ball and the runners going to second base and third base and following the runners and the ball,

In one aspect of the present invention, if play continues and a runner from first base turns for third base, after a cut to another camera following the initial first camera master scene, the second camera is the next master play by play angle selected.

Another exemplary method in accordance with the present invention includes the steps of, after selecting the first or second camera, selecting a third camera, and after selecting a third camera, adjusting the framing of the previously selected first or second camera to include all the key elements of the play, even those that may have been excluded in the initial adjustment. This way, if the previously selected first or second camera is again selected during the continuation of the play, all the key elements of play are framed.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

is a top plan view of a baseball playing field illustrating an exemplary embodiment of the sports television camera assignment in accordance with the present invention;

FIG. 2 is a partial side sectional view thereof along section 2-2; and

FIG. 3 is a partial side sectional view thereof along section 3-3.

### DESCRIPTION OF THE PREFERRED EMBODIMENTS

An exemplary embodiment of a method for baseball television camera assignment in accordance with the present invention is described with reference to FIG. 1, which shows a top plan view of a baseball playing are including the home plate 42, the first base 44 located to the right of the home plate 42, and the first base line 46 therebetween having first base ling midpoint 48. Also shown are the second base 50, a first-to-second midpoint 59, the third base 52, a second-to-third midpoint 58, the third base line 54 between the third base 52 and the home plate 42, and the midpoint thereof, 56. The infield 85 is the area defined by the home plate 42, the first base 44, the second base 50, and the third base 52. A fence 86 extending from a point beyond the first base 44 to a point beyond the third base 52 defines the outer limits of play. The outfield 83 extends from the infield 85 to the fence 86. An accurate grass line 89 extends across the outfield. A dotted center line 81 is shown extending between the home plate and the second base and extending beyond the fence 86. The right field 82 is defined as including those areas of interest, including play areas, to the right of the second base 50 and of the center line 81. The left field 84 is defined as including those areas of interest, including play areas, to the left of the second base 50 and of the center line 81. Line AB is defined as passing through the first base line midpoint 48 and the second-third midpoint 58. Line AC is defined as passing through the third base midpoint 56 and the first-second midpoint 59.

With continued reference to FIG. 1, placement is set forth for camera locations designated CAM1 through CAM9. CAM1 location 62 is located substantially over line AC at height and distance set forth in greater detail shortly. CAM3 location 60 is located substantially over line AB at height and distance set forth in greater detail shortly. CAM2 location 68 is located substantially over the center line 81, behind the home plate 42, at the stadium press box level, where it has an unobstructed view not only of players on the field, but also of announcers in the booth. CAM4 location 70 is located approximately between 0 and 2 meters above line. AC, approximately 20 meters outside the third base line 54. CAM6 location 74 is located approximately between 0 and 2 meters above line AB, approximately 20 meters outside the first base line 46. CAM8 location 72 is located between 0.3 and 2.0 meters above center line 81, approximately 20 meters behind the home plate 42. CAM5 is optionally placed on a moving platform to facilitate placement slightly left of the center line 81 when a left-handed batter is up, and slightly to the right thereof when a right-handed batter is up. CAM7 location 80 is located approximately outside the fence 86 outside left field 84, at approximately the height of the fence 86, typically between 1 and 5 meters, or, in the case of Boston's Fenway Park, all the way up to the 11.3 meter height of the “Green Monster.” CAM9 location 76 is located approximately outside the fence 86 outside right field 82 at a height determined as for CAM7. CAM8 location 78 is located outside the fence 86, slightly to the left of right of the center line 81 (so that the pitcher does not block the view of the batter), at a height determined as for CAM7 and CAM9.

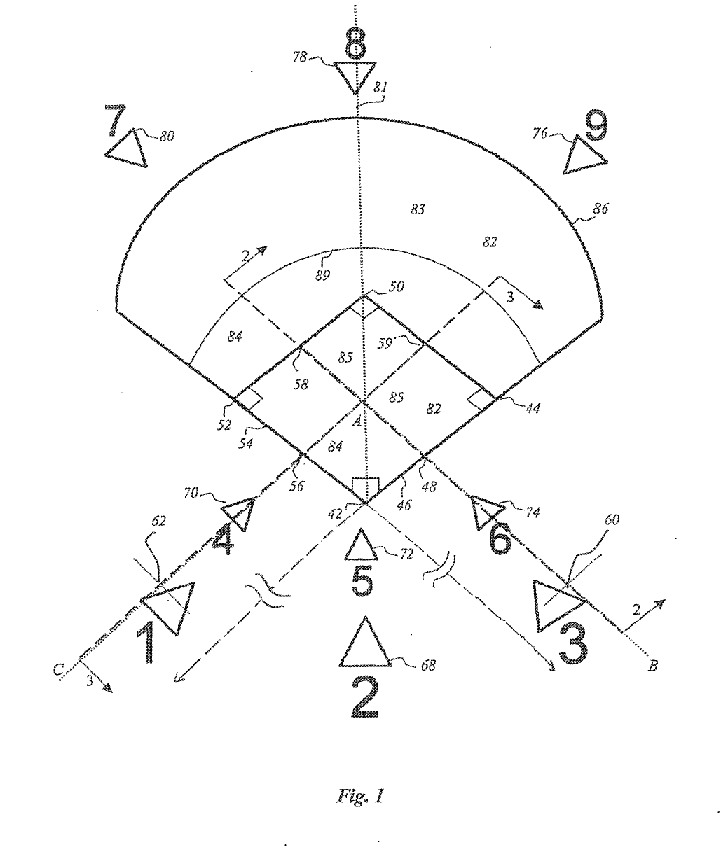

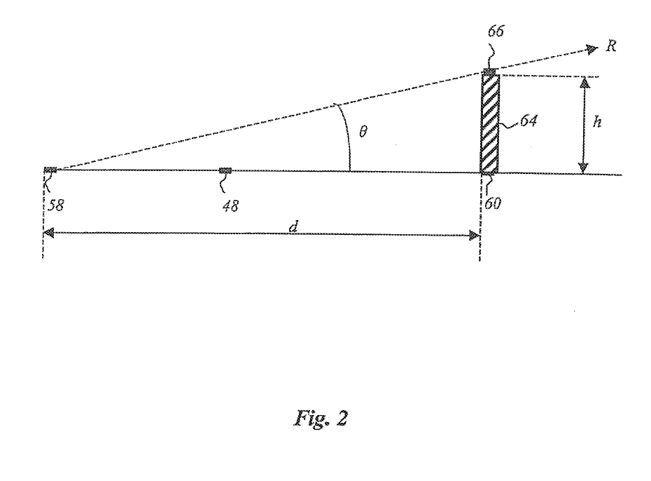

FIG. 2 shows an elevational view of a portion of the play area, taken along section 2-2, including the second-to-third midpoint 58, the first baseline midpoint 28, the CAM3 location 60, CAM3 support 64 holding CAM3 lens 66 at CAM3 height h above CAM3 location 60 and CAM3 distance d from the second-to-third midpoint 58, about which CAM3 ray R subtends CAM3 elevation angle θ above horizontal.

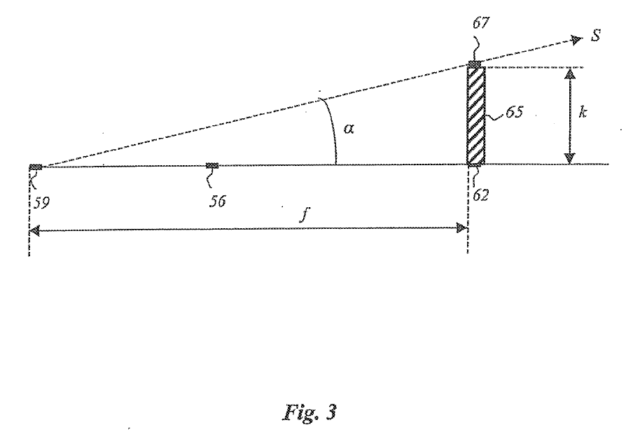

FIG. 3 shows an elevational view of a portion of the play area, taken along section 3-3, including the first-to-second midpoint 59, the third baseline midpoint 56, the CAM1 location 62, CAM1 support 65 holding CAM1 lens 67 at CAM1 height k above CAM1 location 62 and CAM1 distance f from the first-to-second midpoint 59, about which CAM1 ray S subtends CAM1 elevation angle α above horizontal.

In this exemplary method in accordance with the present invention, CAM3 distance d is determined, within the space available at a particular stadium, in a manner which favors smaller angular separations between important elements of the picture acquired from CAM3 location 60. As a result, the camera operator may fit all of the important elements of the action into the picture while composing the picture more tightly than it could be composed using traditional methods. Additionally, the action is shown from an infield angle. This provides a less obstructed view of play. If, for example, CAM1 were placed so it is in line with the second-to-third base path, its view of the action at third base 52—for example, a tag applied to a runner sliding in from second base 50—would often be blocked by the fielder making the play. In accordance with the present invention, CAM1 is shifted toward a relative infield position (toward home plate 42), giving CAM1 an off-axis angle that will reveal more visual information about such a play, as well as showing an infield perspective that the viewing public will experience as somewhat resembling the familiar angle of CAM2. This will help the viewing public to become comfortable with the new angles. Similarly, on the other side of the diamond, if CAM3 were situated in line with the first-to-second base path, then, during close plays at first base 44, the runner would often block the CAM3 view of the first basemen catching the ball. Thus CAM1 and CAM3 each provide a pleasing perspective, so that the viewer will most often get ample visual information on the play. The exemplary method in accordance with the present invention also provides for a plurality of available master shots and a plurality of advantageous camera reassignments, as soon as the ball is in play, and during play. It will be understood that, within the scope of the present invention, under some circumstances, fewer than all of these objects will be achieved to an optimal extent, within the limits of the available space.

Thus, in this exemplary method, pursuit of these concurrent objects, the following are determined:

The CAM3 location 60 is places substantially on line AB, which bisects the first baseline 46, and by selecting CAM3 when play occurs in the left field 84.

In the exemplary method in accordance with the present invention, CAM3 height h is between approximately 5 and 6 meters and CAM3 distance d is 58 meters ±15 meters. This combination of CAM3 height h and CAM3 distance d maintains a low CAM3 elevation angle θ.

More generally in accordance with the present invention, in such a method the CAM3 distance d and the CAM3 height h are determined, within the available space, to minimize the CAM3 elevation angle θ. This is accomplished by lowering the CAM3 height h to a level below those now used in the art, by increasing the CAM3 distance d to a distance greater than those now used in the art, and, more particularly, by a combination of both of these means within the space available. Reducing the CAM3 elevation angle θ reduces thevertical angular separation between the batter, pitcher, and basemen in a master shot (a master shot is a relatively wide-angle picture of a relatively large play area, containing all of the key elements of the play). With increasing CAM3 distance d, the camera's lens is zoomed in tighter to achieve the same composition, with the effect that the greater focal length compresses the distance between the players in the infield 85 and those in the outfield 83.

In an alternative method in accordance with the present invention, the CAM3 distance d and the CAM3 height h are both varied, within whatever constraints are imposed by the environment, such that the CAM3 elevation angle θ is between 3.9 degrees and 7.9 degrees. In yet another alternative method, these parameters are varied to achieve a CAM3 elevation angle θ of 6.1 degrees.

The object of providing for a plurality of available master shots and a plurality of advantageous camera assignments as soon as the ball is in play is accomplished by providing CAM3 in combination with CAM1 in a manner set forth in greater detail below.

CAM1 location 62, CAM1 distance f, and CAM1 height k are determined in the same manner, and with reference to the same objects, as are the corresponding parameters of CAM3, but with reference to the third baseline 54 and, being on the left field 84 side of the play area, are selectable to provide an infield perspective from the side opposite that described with reference to CAM3 above.

With reference again to FIGS. 1 and 2, an alternative method for determining CAM3 height h and. CAM3 distance d is now described. In a particular ballpark, where there is at least one CAM3 location 60 available, an initial point is selected for CAM3 location 60 and the CAM3 lens 66 is placed on the CAM3 support 64. Next, an initial CAM3 height h is set as low as is practicable, based on the existing camera installation environment, such as the existing camera platform and the positions that are available in the stadium for optimizing the camera placement. It is also preferable to set CAM3 height h high enough to have a clear view of the infield 85 and outfield 83 portions of left field 84, as determined by the environment of CAM3. Next, the CAM3 height h and the CAM3 distance d are adjusted with reference to the action on the field. In particular, at least one outfielder in or near left field 84 is framed in CAM3. If the view of that outfielder is blocked or crowded by an infielder, then the CAM3 elevation angle θ is increased until the infielder no longer blocks or crowds the view of the outfielder. This may be accomplished by decreasing CAM3 distance d, by increasing CAM3 height h, or by doing both of these. The resulting CAM3 elevation angle θ strakes a balance between the preference for a low CAM3 elevation angle θ for minimizing angular separation between important elements of a master shot, and the preference for obtaining a relatively unobstructed view of an outfielder. It will be understood that, depending on where the outfielder of interest and the intervening infielder have stationed themselves, the CAM3 elevation angle θ may vary from park to park, game to game, team to team, or play to play. It is contemplated within the scope of the present invention that, as cameras become smaller and more mobile, the methods in accordance with the present invention will include an option step of adjusting CAM3 height h and CAM3 distance d during play in response to the action on the field. Analogously, the same principle will apply to CAM I. It will also be understood that, although the CAM3 elevation angle θ is set forth with explicit reference to the midpoint of the second-third base path 58, the object being pursued in adjusting CAM3 elevation angle θ upward is an un-blocked, un--crowded view of a selected player. Thus, the CAM3 elevation angle θ may be determined with reference to the players themselves or with reference to another feature of the playing field. In any event, the exemplary method in accordance with the present invention departs from the prior art in seeking to optimize the placement of CAM3 in the aforementioned manner, even though it is not always possible for CAM3 to obtain an unobstructed view of every player.

With reference again to FIG. 1, the exemplary method in accordance with the present invention also departs from the prior are in its use and game-play assignments of two master angle play-by-play cameras, CAM3 and CAM1, rather than merely one play-by-play camera. The exemplary method thereby makes tightly composed master shots more frequently available for broadcast, than is the case with a single stationary camera angle. CAM2 is assigned to follow the ball action (ball and fielder or ball, fielder and runner) close up fashion and is available for a live cut whenever the ball and a fielder, or the ball and a runner, converge. This assignment of CAM2 provides a familiar view from behind and above home plate 42. Importantly,this assignment of CAM2 also provides a ready shot of the ball action in the event the play-by-play camera loses the ball. Thus, for example, in the case of an unexpected snap throw, CAM2 may be selected (and, ideally, will always be available for selection) to cover where the ball goes and what action is taking place.

With continued reference to FIG. 1, in this exemplary method, cameras are capable of cooperating in the manner set forth in the paragraphs below. The term “follows” or “following,” means manipulation a camera lens to compose a scene.

CAM1 follows hits to the first base 44 side of the midline 81, including at least the nearest runner to the ball action in frame, viewing them across the infield 85.

CAM2 follows the action involving the ball close up.

CAM3 follows hits to the third base 52 side of the midline 81, including at least the nearest runner to the ball action in frame, viewing them across the infield 85.

CAM4 primarily covers the second base 50 side (to the right of midline 81) of the infield 85 (although CAM4 may also be assigned to provide other coverage) and also has runner assignments, i.e., is assigned to cover certain runners.

CAM8 provides close-up coverage of the infield 85 and, especially, of the pitcher.

CAME primarily covers the shortstop side (to the left of midline 81) of the infield 85 (although CAME may also be assigned to provide other coverage), and also has runner assignments.

CAM7 is behind left field 84.

CAM8 is behind the outfield 83 centrally.

CAM9 is behind right field 82. The “covering” assignments of CAM7, CAM8, and CAM9 vary.

CAMs 5, 7, and 9, as well as other cameras, may be added to the above-described setup of six cameras, (CAMs 1, 2, 3, 4, 6, and 8), to provide isolation angles. For example, a CAM24 (not shown) may be provided at low third to isolate the right side of the infield; a CAM 28 (not shown) may be provided near CAM8 for close-up coverage of players and action at home plate.

The following are the camera assignments for the exemplary method.

The main assignments of CAM1 and CAM3 for game play are the play-by-play master shots. Between Pitches is defined as those periods of time between plays when a pitch is not imminent. At those times, the desirable shots include her© shots (shots of the “hero” of the previous play), the batter who got the hit, the runner who stole a base, the fielder who made the great play, and the like. Other possible shots include base coaches, dugout activities, and base runners (for this, CAM1 and CAM3 will cross shoot: CAM1 gets first base 44; CAM3 gets third base 52). Before The Pitch is defined as the period of time a pitch is or becomes imminent. At these times, CAM1 and CAM3 will set their compositions on their respective master play-by-play angles. Additionally if there is a runner at first base, CAM1 must frame the scene and be prepared for any attempts by the pitcher to “pick off” the runner (to “pick off” a runner is to throw the ball to the fielder at first base in an effort to catch the runner off the base and tag him out). For double play attempts, CAM3 composes a shot including first base 44 and second base 50 for the “1-2-3” cutting sequence. For grounders to the right side, cut to CAM1 for the play-by-play master angle; then cut to CAM2 for the close up of the action at second base 50; then cut to CAM3 for the throw from second base 50 to first base 44. The cutting sequence “3-2-3” is used for possible double play attempts on grounders to the left side.

CAM2's main assignment is to follow the ball action close-up. Between-pitches, CAM2 acquires shots in the manner described above for CAM1 and. CAM3, including base runners, primarily those at second base. Before The Pitch, CAM2 gets ready to follow the ball action close up. CAM2 is ready to compose shots for pick-off attempts (as explained above in the context of CAM1) and umpire appeals. In an umpire appeal, the home plate umpire asks the first or third base umpire (depending on which side of the plate the batter is standing on) to rule a pitch a ball or a strike. This happens after the batter swings at a ball and the ball is called outside the strike zone, but he attempts to stop his swing (a “half swing”).

CAM4's assignments include covering left-handed batters and, where the batter is right-handed and there is no CAM8, covering the pitcher. CAM4 also covers a lead runner at first base 44 (prepared for pick-off attempts), or covers second runners at first base 44 or second base 50, following him until he rounds third base 62; CAM4 then picks up any trailing runner. If CAM4 has a runner assignment and the batter gets a hit, after the play is dead, CAM4 should leave the trailing runner and provide a “hero” shot of the player who hit the ball. If there are no runners, CAM4 isolates the left-handed batter's swing or infield action. To “isolate” action is to compose a shot of that action for slow motion replay.

CAM5 covers the pitcher close-up, provides pitch isolations (close up shots of the pitch as it is delivered to the batter), and provides infield isolations.

CAME covers right-handed batters, and provides pitcher close-ups for left handed batters if there is no CAM8. CAME also covers a lead runner at second back SO or third base 52, follows runners to home plate 42, and handles scoring all runners (following a runner to see when he crosses home plate to score a run). If there are no runners, CAM6 isolates the right--handed batter's swing or isolates infield action for replay. If the only runner is on first base 44 and the batter gets a hit, CAM6 follows the batter-turned-runner until it is time to “score” the lead runner. For example, when a runner from first base 44 rounds third base 52, CAM4 would release him at that time and pick up the training runner. CAM6 must pick up and “score” the lead runner.

CAM7 provides a reverse (of CAM2's) angle isolation of infield plays. CAM7 also provides a shot of the right outfield 82 corner if it is blocked from the view of CAM2. CAM7 also provides isolation of plays in center and right fields. CAM7 can also cover a runner going to first base 44 on hits to left field 84, because he's looking in that direction watching the ball.

CAM8 provides a pitcher-batter shot (a shot composed of the pitcher with his back to the camera, and the hatter, catcher and umpire at home base). CAM8 stays with hits (ground balls and line drives) up the middle. CAM8 can follow a runner to first base 44 on walks and infield hits. CAM8 isolates plays in left field 84 and right field 82, and covers left and right outfield corners if they are blocked from the view of CAM2 and there are no cameras at CAM7 and CAM8.

CAM8 provides revers (of CAM2) angle isolations of infield plays, left outfield 84 corner if it is blocked from the view of CAM2, isolations of plays in center and left fields, and a runner going to first base 44 on hits to right field 82 (because he's looking in that direction watching the ball).

In another exemplary method in accordance with the present invention, when a ball is hit to left field 84, CAM3 is preferred as the master play-by-play camera regardless of the position of any runners.

When a ball is hit to right field 82, CAM1 is preferred as the master play-by-play camera regardless of the position of any runners.

In all situations, if play continues because, for example, a runner tries to stretch it out or a fielder errs, the operators of CAM1 and CAM3 must be ready to adjust their frames to allow for the possible expansion of action. Thus, there is a standing adjustment to be made after the initial play-by-play shot when the ball is put into play. When a different camera's shot is selected after the initial master play-by-play shot, and composition was tightened during the initial master shot, the framing should be adjusted to include all the key elements of the play, even those that may have been excluded in the initial adjustment. When, subsequently, the master scene is selected again during the continuation of the play, it is important to be able to see how all the key elements are positioned anew.

While the play is in progress CAM1 and CAM3 must maintain their respective play-by-play master scenes, because, fairly often, the ball can unexpectedly change direction, requiring a different perspective than the one initially selected. For example, with a runner on first base and the ball is hit to the left side of the infield, CAM3 would be the first selection. The shortstop fields the ball and throws it to second base to start a double play attempt (CAM2 is now selected, to see the ball action at second base close up). However, suppose the throw is inaccurate and goes into right field. CAM2 follows its progress. If the runner attempts to steal third base, CAM3 must now drastically widen its shot in order to keep the ball action and the runner going to third in the frame. It will, very shortly, become an unpleasing composition. The remedy is to select CAM1, whose angle is now the best available to cover the action in a tightly composed master scene.

In another exemplary method in accordance with the present invention, it becomes acceptable to let a runner out of the master frame, because the primary assignments of CAM4 and CAM6 for following the runners allow us to cut to the runners live or reply their actions after the fact.

Toward the object of keeping the play by play angles compressed, hits to center field (the region of the play area near the center line 81) are covered in a manner dependent on whether or not there are runners, and if so, which bases they occupy.

When the ball is hit to center and there are no runners, CAM3 is selected and its frame is tightened about the runner and the ball action. By contrast, if CAM1 were used, these elements diverge as the ball travels to left center field. In the frame of CAM3, they converge no matter where the ball goes in center field.

When the ball is hit to center, and the only runner is on first base 44, CAM3 is selected to frame that runner and the ball action as he approaches second base 50. If play continues and that runner turns for third base 52, after a cut to another camera following the initial CAM3 master scene, CAM1 would be the next master play by play angle selected. CAM1's angle is new the best available to cover the action in a tightly composed master scene, because the ball action in center field and the runner going to third base diverge in CAM3's angle.

With a runner on second base, regardless of the position of any other runners, (including the case in which the bases are loaded) and a ball is hit substantially up the center over the midline 81, CAM1 is preferred as the master play-by-play camera. This runner is important, because he is in scoring position. Because he is important, and because he will run toward CAM1 as he runs for third base, CAM1 should be selected. The operator of CAM1 can tighten the composition to exclude the runner going to first, thereby avoiding a scene which would be too wide, making it harder to see the ball.

Additionally, the view of CAM3, the ball and the runner going to third base would diverge from one another, requiring the operator of CAM3 to widen the shot to an unpleasing degree. If play continues, and after we see the lead runner turn for home, CAM1 can let him go and pick up the next runner nearest to the ball action. If the throw goes home for a play at the plate 42, CAM1 would then widen to frame the ball action and all runners.

If the ball is hit to center and the only runner is on third base 52, CAM3 is selected, and after establishing what the runner is doing (holding or heading for home), CAM3 shifts its frame away from that runner and concentrates on the runner closest to the ball action, or holds all runners in the frame for more information. Because of the nature of the “follow the runners” assignments of CAM4 and CAM6 and the preference for tight framing, it is desirable to concentrate on the runner closest to the ball action.

When the ball is hit to center and there are two runners, one on first base 44 and one on second base 50, cameras are assigned as above for the case in which the ball is hit to center with a runner on second base 50.

When the ball is hit to center and there are runners, one on first base 44 and one on third base 52, cameras are assigned as above for the case in which the ball is hit to center and the only runner is on third base 52.

When the ball is hit to center and there are two runners, one on second base 50 and one on third base 42, cameras are assigned as above for the case in which the ball is hit to center with a runner on second base 50.

When the ball is hit to center and the bases are loaded, cameras are assigned as above for the case in which the ball is hit to center with a runner on second base 50.

In another exemplary method in accordance with the present invention, either CAM3 height h, or CAM1 height k, or both, are limited to a maximum of 10 meters above the level of the playing field, regardless of whether the facilities permit higher placement, and CAM3 distance d and CAM1 distance f are adjusted to minimize the CAM3 elevation angle θ and the CAM1 elevation angle α. This limitation provides camera elevation angles suitable for reducing the angular separation between key elements within each master shot.

1. A camera system for recording a baseball game for a viewing audience or broadcasting the baseball game to the viewing audience, the baseball game being played in a stadium configured for playing baseball, wherein the stadium includes a first base line, a third base line, a home plate, a first base, a second base and a third base, the system comprising:
a first camera position including a first camera, a second camera position including a second camera, and a third camera position including a third camera, said second camera position being disposed to a relative third base side of said first camera, and said third camera position being disposed to a relative first base side of said first camera,
cooperation between said cameras allowing for a camera arrangement configured such that at least one of said second camera and said third camera is selected by a broadcasting entity as a primary play-by-play camera for recording the baseball game for the viewing audience or broadcasting the baseball game to the viewing audience.

2. The camera system of claim 1, wherein said first camera position is disposed such that home plate is substantially between said first camera and second base, said first camera position being delimited by a perpetual reverse extension of the third base line through home plate and away from third base and a perpetual reverse extension of the first base line through home plate and away from first base, wherein said second camera position is disposed such that the third base line is substantially between said second camera and second base, and in any area positioned to a third base side of said perpetual reverse extension of the first base line, and wherein said third camera position is disposed such that the first base line is substantially between said third camera and second base, and in any area positioned to a first base side of said perpetual reverse extension of the third base line.

3. The system of claim 1, wherein said primary play-by-play camera is configured to provide a first view of a play after a player hits a ball.

4. The system of claim 3, wherein said second camera is configured to be selected as said primary play-by-play camera when said player hits a ball to a relative first base side of second base, and wherein said third camera is configured to be selected as said primary play-by-play camera when said player hits a ball to a relative third base side of second base.

5. The camera system of claim 1, wherein said second camera is located substantially equidistant from home plate and third base, and wherein said third camera is located substantially equidistant from home plate and first base.

6. The camera system of claim 1, wherein said first camera, said second camera, and said third camera are disposed on a ray rising at an angle less than 7.9 degrees above horizontal from an origin between first base and second base or second base and third base.

7. The camera system of claim 1, wherein said first camera, said second camera, and said third camera are disposed at a height of between 5 meters and 6 meters above ground.

8. The camera system of claim 3, wherein said first camera is configured to follow and isolate play action close up after provision of said first view from said primary play-by-play camera.

9. A method for recording a baseball game for a viewing audience or broadcasting the baseball game to the viewing audience, the baseball game being played in a stadium configured for playing baseball, wherein the stadium includes a first base line, a third base line, a home plate, a first base, a second base and a third base, the method comprising:
disposing a first camera in a first camera position section;
disposing a second camera in a second camera position section;
disposing a third camera in a third camera position section, said second camera position being disposed to a relative third base side of said first camera, and said third camera position being disposed to a relative first base side of said first camera;
selection, by a broadcasting entity, of at least one of said second camera and said third camera as a primary play-by-play camera for recording or broadcasting the baseball game;
recording or broadcasting the baseball game using at least one of said second camera and said third camera as said primary play-by-play camera, wherein said selecting of at least one of said second camera and said third camera as a primary play-by-play camera is done for the viewing audience by the broadcasting entity.

10. The method of claim 9, wherein said first camera position is disposed such that home plate is substantially between said first camera and second base, said first camera position being delimited by a perpetual reverse extension of the third base line through home plate and away from third base and a perpetual reverse extension of the first base line through home plate and away from first base, wherein said second camera position is disposed such that the third base line is substantially between said second camera and second base, and in any area positioned to a third base side of said perpetual reverse extension of the first base line, and wherein said third camera position is disposed such that the first base line is substantially between said third camera and second base, and in any area positioned to a first base side of said perpetual reverse extension of the third base line.

11. The method of claim 9, further including providing a first view of a play after a player hits a ball via said primary play-by-play camera.

12. The method of claim 11, further including selecting said second camera as said primary play-by-play camera when said player hits a ball to a relative first base side of second base, and further including selecting said third camera as said primary play-by-play camera when said player hits a ball to a relative third base side of second base.

13. The method of claim 9, further including locating said second camera substantially equidistantly from home plate and third base, and further including locating said third camera substantially equidistantly from home plate and first base.

14. The method of claim 9, further including disposing said first camera, said second camera, and said third camera on a ray rising at an angle less than 7.9 degrees above horizontal from an origin between first base and second base or second base and third base.

15. The method of claim 9, further disposing said first camera, said second camera, and said third camera, at a height of between 5 meters and 6 meters above ground.

16. The method of claim 9, further including using said first camera to follow and isolate play action close up after provision of said first view from said primary play-by-play camera.

17. The camera system of claim 1, wherein said primary play-by-play camera is configured to capture at least initial live action of a hatted ball and at least one base line.

18. The method of claim 9, wherein said primary play-by-play camera is configured to capture at least initial live action of a batted ball and at least one base line.

19. The camera system of claim 1, wherein one of said second camera and said third camera is selected for the viewing audience as said primary play-by-play camera based on which side of second base a batted ball is hit.

20. The method of claim 9, wherein one of said second camera and said third camera is selected for the viewing audience as said primary play-by-play camera based on which side of second base a batted ball is hit.

21. The camera system of claim 1, wherein at least one of said second camera and said third camera is selectable for the viewing audience as said primary play-by-play camera independently of any input from a non-broadcasting entity.

22. The camera method of claim 9, wherein at least one of said second camera and said third camera is selected for the viewing audience as said primary play-by-play camera independently of any input from a non-broadcasting entity.
